(19) United States
(12) Patent Application Publication
(10) Pub. No.: US 2013/0213245 A1
(43) Pub. Date: Aug. 22, 2013

(54) METHOD OF PRESSURIZING A SUBSTANCE

(71) Applicants: Roy Walter Henderson, Cape Town (ZA); Jan Abraham Vlok, Cape Town (ZA)

(72) Inventors: Roy Walter Henderson, Cape Town (ZA); Jan Abraham Vlok, Cape Town (ZA)

(73) Assignees: Jan Abraham VLOK, Cape Town (ZA); Roy Walter HENDERSON, Cape Town (ZA)

(21) Appl. No.: 13/882,717

(22) PCT Filed: May 28, 2012
(86) PCT No.: PCT/ZA2012/000041

§ 371 Date: Apr. 30, 2013

(30) Foreign Application Priority Data
May 26, 2011 (ZA) 2011/03868

(51) Int. Cl. B30B 9/04

(52) U.S. Cl. CPC B30B 9/047
USPC 100/37; 100/111

(57) ABSTRACT

A pressure inducing device 10 for pressurizing a substance is provided. The device 10 includes a body 12, a pressure chamber 14 defined by the body 12 and an inlet 18 leading into the pressure chamber 14 through which inlet 18 a substance to be pressurized can be fed into the pressure chamber 14. A piston 22 is arranged to travel along the pressure chamber 14 to pressurize a substance in the pressure chamber 14. An outlet 20 leads from the pressure chamber 14. A blocking member 28 is arranged to open the outlet 20 after the substance has been pressurized in the pressure chamber 14 thereby to permit the pressurized substance to expel under pressure through the outlet 20 in response to opening the outlet 20.

### FIELD OF THE INVENTION

The invention relates to a method of pressurizing a substance. In particular, the invention relates to a method of pressurizing a substance and to a pressure inducing device for pressurizing a substance.

### BACKGROUND OF THE INVENTION

The method of pressurizing a substance and the pressure inducing device for pressurizing a substance, in accordance with the invention, can advantageously be used for the extraction of substances from organic material of various types. For example, nuts, seeds, fruits, vegetables, tree bark, leaves, roots, fish, meat, milk, beer, plant material, in general, can be pressurized in the pressure inducing device to cause cell membrane, or wall, rupture. The pressure inducing device for pressurizing a substance, in accordance with the invention, can be used in the nutritional industry, the fertilizer industry, the beverage industry, and the like, for example.

### SUMMARY OF THE INVENTION

According to one aspect of the invention, there is provided a method of pressurizing a substance, the method including providing a pressure inducing device defining a pressure chamber, an inlet leading into the pressure chamber, an outlet leading from the pressure chamber, a blocking member for selectively blocking the outlet and a piston arranged to travel along the chamber to pressurize the chamber, feeding a substance into the pressure chamber through the inlet, advancing the piston into an extended condition into the pressure chamber, while the outlet is blocked by the blocking member, thereby to pressurize the substance in the pressure chamber, and displacing the blocking member to open the outlet after the substance has been pressurized in the pressure chamber thereby to permit the pressurized substance to expel under pressure through the outlet in response to opening the outlet.

The outlet may be in the form of an outlet passage having a predetermined length, displacing the blocking member to open the outlet after the substance has been pressurized in the pressure chamber then including permitting the pressurized substance to expel under pressure through the outlet passage of predetermined length in response to opening the outlet.

The outlet passage may lead from the pressure chamber at an end of the pressure chamber opposed from the piston when in a retracted condition, permitting the pressurized substance to expel under pressure through the outlet passage of predetermined length in response to opening the outlet then including permitting the pressurized substance to expel under pressure through the outlet passage of predetermined length at the end of the pressure chamber opposed from the piston when in a retracted condition.

The blocking member may be displaceable from a blocking condition, in which the blocking member blocks the outlet to close the outlet, and a removed condition, in which the blocking member is removed from the outlet to open the outlet, the method including displacing the blocking member between the blocking condition and the removed condition respectively to close and to open the outlet passage.

The blocking member may define a generally conically shaped head. The outlet may define a complementary conical seat. Displacing the blocking member between the blocking condition and the removed condition respectively to close and to open the outlet may include seating the generally conically shaped head in the complementary conical seat.

A taper of the generally conically shaped head and a taper of the associated conical seat may be dissimilar, displacing the blocking member between the blocking condition and the removed condition respectively to close and to open the outlet then including seating the generally conically shaped head in the associated conical seat to seat by means of a line contact with the seat.

The pressure inducing device may further define an expansion chamber downstream of the outlet, permitting the pressurized substance to expel under pressure through the outlet in response to opening the outlet then including permitting the pressurized substance to expel and expand into the expansion chamber.

The pressure inducing device may further define an expansion chamber outlet, the method including permitting the expanded substance to pass from the expansion chamber to a desired location through the expansion chamber outlet.

The inlet may be positioned to open into the pressure chamber when the piston is in a retracted condition and to be closed by the piston as the piston is advanced into the pressure chamber from the retracted condition. The method may then include advancing the piston to close the inlet and into an extended condition into the pressure chamber, while the outlet is in a closed condition, thereby to pressurize the substance in the pressure chamber after a substance is fed into the pressure chamber through the inlet.

According to another aspect of the invention, there is provided a pressure inducing device for pressurizing a substance, the device including a body, a pressure chamber defined by the body, an inlet leading into the pressure chamber through which inlet a substance to be pressurized can be fed into the pressure chamber, a piston arranged to travel along the pressure chamber to pressurize a substance in the pressure chamber, an outlet leading from the pressure chamber and a blocking member arranged to open the outlet after the substance has been pressurized in the pressure chamber thereby to permit the pressurized substance to expel under pressure through the outlet in response to opening the outlet.

The outlet may be in the form of an outlet passage having a predetermined length.

The outlet may lead from the pressure chamber at an end of the pressure chamber opposed from the piston when in a retracted condition.

The blocking member may be displaceable from a blocking condition, in which the blocking member blocks the outlet to close the outlet, and a removed condition, in which the blocking member is removed from the outlet to open the outlet.

The blocking member may define a generally conically shaped head. The outlet may define a complementary conical seat.

A taper of the generally conically shaped head and a taper of the associated conical seat may be dissimilar, such that the blocking member forms a line contact with the associated conical seat when in a blocking condition.

The pressure inducing device may define an expansion chamber downstream of the outlet.

The pressure inducing device may define an expansion chamber outlet leading from the expansion chamber.

The inlet may be positioned to open into the pressure chamber when the piston is in a retracted condition and to be closed by the piston as the piston is advanced into the pressure chamber from the retracted condition.

The piston may be arranged to advance from a retracted condition into the pressure chamber to close the inlet and into an extended condition in the pressure chamber, while the outlet is in a closed condition, thereby to pressurize the substance in the pressure chamber.

The outlet may be arranged to open after the substance has been pressurized in the pressure chamber thereby to enable the substance to expel from the pressure chamber through the outlet.

The pressure inducing device may be arranged to retract the piston from the extended condition to the retracted condition to open the inlet so as to allow a fresh supply of substance to be fed into the pressure chamber and then again to advance the piston to close the inlet and into the extended condition into the pressure chamber, while the outlet is in a closed condition, thereby to pressurize the fresh supply of substance in the pressure chamber.

The pressure inducing device may include a hydraulically powered motor for driving the piston to travel between the retracted position and the extended position in the pressure chamber.

The pressure inducing device may include a hydraulically powered motor for driving the blocking member to displace between the blocking condition and the removed condition.

According to another aspect of the invention, there is provided a method of pressurizing a substance, the method including providing a pressure inducing device defining a pressure chamber, an inlet leading into the pressure chamber, an outlet leading from the pressure chamber, and a piston arranged to travel along the chamber to pressurize the chamber, the inlet being positioned to open into the pressure chamber when the piston is in a retracted condition and to be closed by the piston as the piston is advanced into the pressure chamber from the retracted condition, feeding a substance into the pressure chamber through the inlet, advancing the piston to close the inlet and into an extended condition into the pressure chamber, while the outlet is in a closed condition, thereby to pressurize the substance in the pressure chamber and opening the outlet after the substance has been pressurized in the pressure chamber thereby to enable the substance to exit the pressure chamber.

Feeding the substance into the pressure chamber may include permitting the substance to gravitate into the pressure chamber through the inlet. Instead, or in addition, feeding the substance into the pressure chamber may include feeding the substance into the pressure chamber under pressure. Instead, or in addition, feeding the substance into the pressure chamber may include using a low pressure formed in the pressure chamber to suck the substance into the pressure chamber.

Permitting the substance to gravitate into the pressure chamber through the inlet may include containing the substance in a hopper operatively above the inlet.

The method may further include retracting the piston from the extended condition to the retracted condition to open the inlet so as to allow a fresh supply of substance to be fed into the pressure chamber and then again to advance the piston to close the inlet and into an extended condition into the pressure chamber, while the outlet is in a closed condition, thereby to pressurize the fresh supply of substance in the pressure chamber.

The outlet may be in the form of an outlet passage leading from the pressure chamber at an end of the pressure chamber opposed from the piston when in a retracted condition, the method including permitting the pressurized substance to expel under pressure through the outlet passage in response to opening the outlet.

The pressure inducing device may define a blocking member for blocking the outlet, the blocking member being displaceable from a blocking condition, in which the blocking member blocks the outlet to close the outlet, and a removed condition, in which the blocking member is removed from the outlet to open the outlet, the method including displacing the blocking member between the blocking condition and the removed condition respectively to close and to open the outlet.

The blocking member may define a generally conically shaped head and the outlet may define a complementary conical seat, displacing the blocking member between the blocking condition and the removed condition respectively to close and to open the outlet, then including seating the generally conically shaped head in the complementary conical seat. Instead, the blocking member may define a generally conically shaped head and the outlet may define an associated conical seat, a taper of the generally conically shaped head and the associated conical seat being dissimilar, displacing the blocking member between the blocking condition and the removed condition respectively to close and to open the outlet, then including seating the generally conically shaped head in the associated conical seat to seat by means of a line contact with the seat.

The pressure inducing device may define an expansion chamber downstream of the outlet, permitting the pressurized substance to expel under pressure through the outlet passage in response to opening the outlet, then including permitting the pressurized substance to expel and expand into the expansion chamber.

The pressure inducing device may define an expansion chamber outlet, the method including permitting the expanded substance to pass from the expansion chamber to a desired location through the expansion chamber outlet.

The expansion chamber outlet may be defined at an upper region of the expansion chamber, the method including collecting debris in the expansion chamber and permitting a desired portion of the expanded substance to pass through the expansion chamber outlet.

According to another aspect of the invention, there is provided a pressure inducing device for pressurizing a substance, the device including a body, a pressure chamber defined by the body, an inlet leading into the pressure chamber, an outlet leading from the pressure chamber and a piston arranged to travel along the pressure chamber to pressurize the chamber, the inlet being positioned to open into the pressure chamber when the piston is in a retracted condition and to be closed by the piston as the piston is advanced into the pressure chamber from the retracted condition.

The pressure inducing device may further include feed means for feeding a substance into the pressure chamber through the inlet.

The feed means may be arranged to enable the substance to gravitate into the pressure chamber through the inlet.

The feed means may include a hopper positioned operatively above the inlet.

The piston may be arranged to advance from a retracted condition into the pressure chamber to close the inlet and into an extended condition in the pressure chamber, while the outlet is in a closed condition, thereby to pressurize the substance in the pressure chamber.

The outlet may be arranged to open after the substance has been pressurized in the pressure chamber thereby to enable the substance to exit the pressure chamber.

The pressure inducing device may be arranged to retract the piston from the extended condition to the retracted condition to open the inlet so as to allow a fresh supply of substance to be fed into the pressure chamber and then again to advance the piston to close the inlet and into the extended condition into the pressure chamber, while the outlet is in a closed condition, thereby to pressurize the fresh supply of substance in the pressure chamber.

The outlet may be in the form of an outlet passage leading from the pressure chamber, at an end of the pressure chamber opposed from the piston when in a retracted condition.

The pressure inducing device may define a blocking member for blocking the outlet, the blocking member being displaceable from a blocking condition, in which the blocking member blocks the outlet to close the outlet, and a removed condition, in which the blocking member is removed from the outlet to open the outlet.

The blocking member may define a generally conically shaped head and the outlet may define a complementary conical seat, displacing the blocking member between the blocking condition and the removed condition respectively to close and to open the outlet including seating the generally conically shaped head in the complementary conical seat.

The blocking member may define a generally conically shaped head and the outlet may define an associated conical seat, a taper of the generally conically shaped head and the associated conical seat being dissimilar, displacing the blocking member between the blocking condition and the removed condition respectively to close and to open the outlet, then including seating the generally conically shaped head in the associated conical seat to seat by means of line contact with the seat.

The pressure inducing device may define an expansion chamber downstream of the outlet.

The pressure inducing device may define an expansion chamber outlet.

The expansion chamber outlet may be defined at an upper region of the expansion chamber to permit debris to be held in the expansion chamber while a desired portion of the expanded substance is permitted to pass through the expansion chamber outlet.

The pressure inducing device may include a hydraulically powered motor for driving the piston to travel between the retracted position and the extended position in the pressure chamber.

The pressure inducing device may include a hydraulically powered motor for driving the blocking member to displace between the blocking condition and the removed condition.

### BRIEF DESCRIPTION OF THE DRAWINGS

Embodiments of the invention will now be described, by way of example, with reference to the accompanying diagrammatic drawings, in which:

FIG. 1 shows a schematic sectional side view of a pressure inducing device for pressurizing a substance, in accordance with an embodiment of the invention; and

FIG. 2 shows a schematic sectional side view of an outlet portion of another pressure inducing device for pressurizing a substance, in accordance with an embodiment of the invention.

### DETAILED DESCRIPTION OF PREFERRED EMBODIMENTS

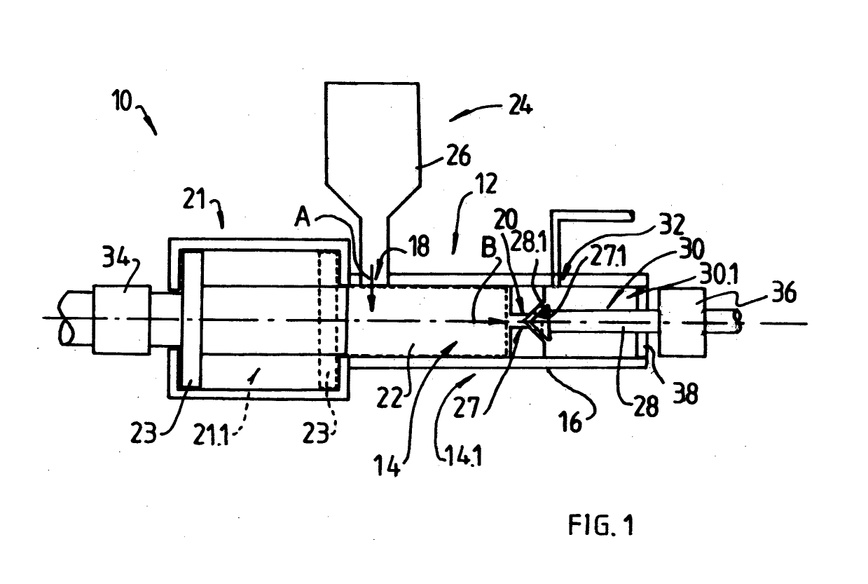

In FIG. 1 of the drawings, a pressure inducing device for pressurizing a substance, in accordance with an embodiment of the invention, is generally indicated by reference numeral 10.

The pressure inducing device 10 defines a body, generally indicated by reference numeral 12. The body 12 defines a pressure chamber 14. The pressure chamber 14 can define a volume of between about 500 cc and about 5000 cc. Typically, the pressure chamber 14 can define a volume of between about 800 cc and about 2000 cc. Advantageously, the pressure chamber 14 defines a volume of about 1000 cc. The pressure chamber 14 can define an internal diameter of between about 20 mm and about 200 mm. Typically, the pressure chamber 14 defines an internal diameter of between about 30 mm and about 100 mm. Advantageously, the pressure chamber 14 defines an internal diameter of about 40 mm, for example. However, it will be appreciated that the pressure chamber 14 can define any appropriate volume and internal diameter, depending on design constraints, production volume, and the like, for example. Advantageously, the pressure chamber 14 is defined within a cylindrical portion 16 of the body 12. A polished inner steel wall can define the pressure chamber 14. An inlet 18 is provided. The inlet 18 leads into the pressure chamber 14, as indicated by arrow A. An outlet 20 leads from the pressure chamber 14, as indicated by arrow B.

The pressure inducing device 10 further defines a piston 22. The piston 22 is arranged to travel along the pressure chamber 14 to pressurize the pressure chamber 14. A typical tolerance between the piston 22 and a pressure chamber wall, is between about 5 to 10 micron, such as, about 8 micron. The piston 22 can include a Vesconite alloy layer, or a layer of any other appropriate material, at a leading end. The rest of the piston 22 can be of an appropriate steel material. The inlet 18 is positioned to open into the pressure chamber 14 when the piston 22 is in a retracted condition, as indicated in solid lines in the drawing. The inlet 18 is positioned such that the inlet 18 is closed by the piston 22 as the piston 22 is advanced into the pressure chamber 14 from the retracted condition, as indicated in phantom lines in the drawing.

In one embodiment, the piston 22 is driven by a pressure converting arrangement 21 which converts a lower pressure of about 200 to 225 bar at 21.1 on one side of a master piston 23 to about 1000 bar to 1225 bar in the pressure chamber 14 by the piston 22, in use, for example. However, it is believed that a lower pressure of about 20 bar to 400 bar can be provided depending on the application.

The pressure inducing device 10 further include feed means, generally indicated by reference numeral 24, for feeding a substance into the pressure chamber 14 through the inlet 18. Advantageously, the feed means 24 is arranged to enable the substance to gravitate into the pressure chamber 14 through the inlet 18. Typically, the feed mean 24 includes a hopper 26 positioned operatively above the inlet 18. The hopper 26 can be pressurized to feed the substance into the pressure chamber 14 under pressure. Instead, or in addition, the feed means 24 can be arranged to feed the substance into the pressure chamber 14 by using a low pressure formed in the pressure chamber 14 to suck the substance into the pressure chamber 14.

The piston 22 is arranged to advance from a retracted condition, as indicated in solid lines in the drawing, into the pressure chamber 14, to close the inlet 18, and into an extended condition in the pressure chamber 14, as indicated in phantom lines in the drawing, while the outlet 20 is in a closed condition, thereby to pressurize the substance in the pressure chamber 14.

The outlet 20 is arranged to open after the substance has been pressurized in the pressure chamber 14, thereby to enable the substance to exit the pressure chamber 14.

The pressure inducing device 10 is arranged to retract the piston 22 from the extended condition to the retracted condition to open the inlet 18 so as to permit a fresh supply of substance to be fed into the pressure chamber 14 through the inlet 18 and then again to advance the piston 22 to close the inlet 18 and into the extended condition into the pressure chamber 14. The outlet 20 is then in a closed condition, thereby to pressurize the fresh supply of substance in the pressure chamber 14.

The outlet 20 is defined at the end of an outlet passage 27 leading from the pressure chamber 14 at an end 14.1 of the pressure chamber 14 opposed from the piston 22 when in a retracted condition. Typically, the outlet passage 27 can have an internal diameter of about 4 mm and a length of about 5 cm. However, the internal diameter and the length can vary depending on the application. A blocking member 28 for blocking the outlet 20 is provided. The blocking member 28 is displaceable from a blocking condition, as indicated in phantom lines in the drawing, in which the blocking member 28 blocks the outlet 20 to close the outlet 20, and a removed condition, as indicated in solid lines in the drawing, in which the blocking member 28 is removed from the outlet 20 to open the outlet 20.

Advantageously, the blocking member 28 defines a generally conically shaped head 28.1. Advantageously, the generally conically shaped head 28.1 is of a hard material, such as, tungsten, or the like, for example. The outlet 20 defines a complementary conical seat 27.1. When the blocking member 28 is displaced between the blocking condition and the removed condition respectively, to close and to open the outlet 20, the generally conically shaped head 28.1 unseats and seats in the complementary conical seat 27.1. The seat 27.1 can be defined by a hard material, such as, tungsten, or the like, for example, as well. The blocking member 28 can pass through a sacrificial Scotsman at 38.

The pressure inducing device 10 defines an expansion chamber, generally indicated by reference numeral 30, downstream of the outlet 20. An expansion chamber outlet is defined at 32. The expansion chamber outlet 32 can be defined at an upper region 30.1 of the expansion chamber 30 to permit debris to be held in the expansion chamber 30 while a desired portion of the expanded substance is permitted to pass through the expansion chamber outlet 32. Instead, the expansion chamber outlet can be positioned at any appropriate position leading from the expansion chamber 30, such as at a lower position, to permit expanded material expelled from the outlet 20 to gravitate from the expansion chamber 30.

The pressure inducing device 10 include a hydraulically powered motor 34 for driving the piston 22 to travel between the retracted position and the extended position in the pressure chamber 14. The pressure inducing device 10 further includes a hydraulically powered motor 36 for driving the blocking member 28 to displace between the blocking condition and the removed condition. The hydraulically powered motors 34, 36 are operatively associated so that the timing of the opening and closing of the outlet 20 corresponds with a desired position of the piston 22 relative to the pressure chamber 14. Instead, or in addition, the blocking member 28 can be spring loaded. The spring can then be arranged to cause the outlet 20 to open at a desired internal pressure in the pressure chamber 14.

In use, a substance to be subjected to hyperbaric pressure is contained in the hopper 26. When the piston 22 is in a retracted condition, the inlet 18 is open. Accordingly, a supply of substance is permitted to gravitate, to be fed under pressure, and/or to be sucked from the hopper 26 into the pressure chamber 14. The piston 22 is then driven to travel toward the extended condition, in the pressure chamber 14. As the piston 22 travels beyond the inlet 18, the piston 22 closes the inlet 18 and causes the pressure chamber 14 to be pressurized. It will be appreciated that the outlet 20 is then closed. When the piston 22 has reached a fully extended condition, thereby having caused the substance in the pressure chamber 14 to be subjected to hyperbaric pressure, the outlet 20 is opened. To open the outlet 20, the blocking member 28 is caused to displace so as to unseat the generally conically shaped head 28.1 from the complementary conical seat 27.1. In consequence, the pressurized substance in the pressure chamber 14 then expels under pressure from the pressure chamber 14 through the outlet 20 and into the expansion chamber 30. The outlet 20 is then closed and the process is repeated. As the piston 22 is retracted and again passes the inlet 18, a resultant low pressure, or vacuum, in the pressure chamber 14 assists in drawing a fresh supply of substance into the pressure chamber 14 under gravity.

It will be appreciated that, as the piston 22 passes the inlet 18, the piston 22 cuts any parts of the substance extending partially into the pressure chamber 14 from the inlet 18.

From the expansion chamber 30, the substance is expelled through the expansion chamber outlet 32.

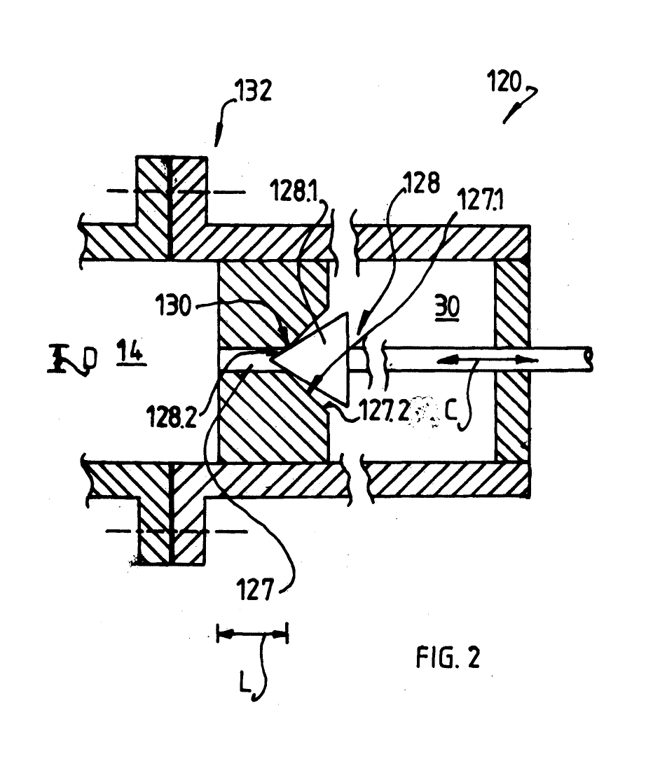

Referring now to FIG. 2 of the drawings, in which like reference numerals have been used to designate similar parts, or features, unless otherwise stated, a different outlet arrangement for the pressure inducing device 10, is generally indicated by reference numeral 120.

The outlet arrangement 120 provides for a blocking member 128, defining a generally conically shaped head 128.1, and an outlet passage 127. The outlet passage 127 defines an associated conical seat 127.1. A taper 128.2 of the generally conically shaped head 128.1 and a taper 127.2 of the associated conical seat 127.1 are dissimilar. Accordingly, when the blocking member 128 is displaced between the blocking condition, as shown in FIG. 2 of the drawings, and the removed condition, as indicated by arrows C, the generally conically shaped head 128.1 seats in the associated conical seat 127.1 by means of a line contact at 130. It has been found that by providing such a line contact between the generally conically shaped head 128.1 and the associated conical seat 127.1, sealing is enhanced. In addition, any relatively large pieces of substance, or fiber, or the like, for example, which may be positioned between the generally conically shaped head 128.1 and the associated conical seat 127.1 upon sealing, is relatively easily severed so as to inhibit the relatively large pieces of substance from obstructing adequate sealing between the generally conically shaped head 128.1 and the associated conical seat 127.1.

It has been found that an optimum ratio of a length L of the outlet passage 127 and a diameter D of the outlet passage 127 varies, depending on the substance being pressurized in the pressure inducing device 10. For example, the ratio for optimum results varies between a substance in the form of seedless fruit and a substance in the form of fruit having seeds. To this end, the outlet arrangement 120 is releasably mounted relative to the rest of the pressure inducing device 10, as indicated at 132. An appropriate flange arrangement can be provided at 132 for enabling the outlet arrangement 120 to be dismounted from the rest of the pressure inducing device 10 by means of conventional fasteners, such as, nuts and bolts, or the like, for example. Accordingly, the outlet arrangement 120 can be dismounted from the rest of the pressure inducing device 10 and another outlet arrangement having a different ratio of length L to diameter D can be mounted onto the rest of the pressure inducing device 10 instead.

Although a generally conically shaped head 128.1 is provided, it will be appreciated that the head can be of any other appropriate shape, such as, rounded, pyramidal, or the like, for example. In such a case, it will be appreciated that the outlet defines a seat arranged to close in response to the head being in a seated condition in the seat.

In another embodiment of the invention, the inlet is provided with a blocking member to function in a similar fashion to the blocking member 27, 127.1. In such a case, the inlet can be positioned to open into the pressure chamber 14 at any appropriate position, such as, in close proximity to the outlet 20. It will be appreciated that the opening and closing of the inlet is then independent of the piston traveling past the inlet to close the inlet.

1. A method of pressurizing a substance, the method including:
providing a pressure inducing device defining a pressure chamber, an inlet leading into the pressure chamber, an outlet leading from the pressure chamber the outlet being in the form of an outlet passage having a predetermined length, a blocking member for selectively blocking the outlet and a piston arranged to travel along the chamber to pressurize the chamber;
feeding a substance into the pressure chamber through the inlet;
advancing the piston into an extended condition into the pressure chamber, while the outlet is blocked by the blocking member, thereby to pressurize the substance in the pressure chamber; and
displacing the blocking member to open the outlet after the substance has been pressurized in the pressure chamber thereby to permit the pressurized substance to expel under pressure through the outlet in response to opening the outlet.

2. (canceled)

3. The method of pressurizing a substance as claimed in claim 1, in which the outlet passage leads from the pressure chamber at an end of the pressure chamber opposed from the piston when in a retracted condition, permitting the pressurized substance to expel under pressure through the outlet passage of predetermined length in response to opening the outlet then including permitting the pressurized substance to expel under pressure through the outlet passage of predetermined length at the end of the pressure chamber opposed from the piston when in a retracted condition.

4. The method of pressurizing a substance as claimed in claim 1, in which the blocking member is displaceable from a blocking condition, in which the blocking member blocks the outlet to close the outlet, and a removed condition, in which the blocking member is removed from the outlet to open the outlet, the method including displacing the blocking member between the blocking condition and the removed condition respectively to close and to open the outlet.

5. The method of pressurizing a substance as claimed in claim 3, in which the blocking member defines a generally conically shaped head and the outlet defines a complementary conical seat, displacing the blocking member between the blocking condition and the removed condition respectively to close and to open the outlet then including seating the generally conically shaped head in the complementary conical seat.

6. The method of pressurizing a substance as claimed in claim 4, in which a taper of the generally conically shaped head and a taper of the associated conical seat are dissimilar, displacing the blocking member between the blocking condition and the removed condition respectively to close and to open the outlet then including seating the generally conically shaped head in the associated conical seat to seat by means of a line contact with the seat.

7. The method of pressurizing a substance as claimed in claim 1, in which the pressure inducing device further defines an expansion chamber downstream of the outlet, permitting the pressurized substance to expel under pressure through the outlet in response to opening the outlet then including permitting the pressurized substance to expel and expand into the expansion chamber.

8. The method of pressurizing a substance as claimed in claim 6, in which the pressure inducing device further defines an expansion chamber outlet, the method including permitting the expanded substance to pass from the expansion chamber to a desired location through the expansion chamber outlet.

9. The method of pressurizing a substance as claimed in claim 1, in which the inlet is positioned to open into the pressure chamber when the piston is in a retracted condition and to be closed by the piston as the piston is advanced into the pressure chamber from the retracted condition, the method including advancing the piston to close the inlet and into an extended condition into the pressure chamber, while the outlet is in a closed condition, thereby to pressurize the substance in the pressure chamber after a substance is fed into the pressure chamber through the inlet.

10. A pressure inducing device for pressurizing a substance, the device including:
a body,
a pressure chamber defined by the body;
an inlet leading into the pressure chamber through which inlet a substance to be pressurized can be fed into the pressure chamber;
a piston arranged to travel along the pressure chamber to pressurize a substance in the pressure chamber;
an outlet leading from the pressure chamber in which the outlet is in the form of an outlet passage having a predetermined length; and
a blocking member arranged to open the outlet after the substance has been pressurized in the pressure chamber thereby to permit the pressurized substance to expel under pressure through the outlet in response to opening the outlet.

11. (canceled)

12. The pressure inducing device for pressurizing a substance as claimed in claim 10, in which the outlet leads from the pressure chamber at an end of the pressure chamber opposed from the piston when in retracted condition.

13. The pressure inducing device for pressurizing a substance as claimed in claim 10, in which the blocking member is displaceable from a blocking condition, in which the blocking member blocks the outlet to close the outlet, and a removed condition, in which the blocking member is removed from the outlet to open the outlet.

14. The pressure inducing device for pressurizing a substance as claimed in claim 10, in which the blocking member defines a generally conically shaped head and the outlet defines a complementary conical seat.

15. The pressure inducing device for pressurizing a substance as claimed in claim 12, in which a taper of the generally conically shaped head and a taper of the associated conical seat are dissimilar, such that the blocking member forms a line contact with the associated conical seat when in a blocking condition.

16. The pressure inducing device for pressurizing a substance as claimed in claim 10, in which the pressure inducing device defines an expansion chamber downstream of the outlet.

17. The pressure inducing device for pressurizing a substance as claimed in claim 14, in which the pressure inducing device defines an expansion chamber outlet leading from the expansion chamber.

18. The pressure inducing device for pressurizing a substance as claimed in claim 10, in which the inlet is positioned to open into the pressure chamber when the piston is in a retracted condition and to be closed by the piston as the piston is advanced into the pressure chamber from the retracted condition.

19. The pressure inducing device for pressurizing a substance as claimed in claim 16, in which the piston is arranged to advance from a retracted condition into the pressure chamber to close the inlet and into an extended condition in the pressure chamber, while the outlet is in a closed condition, thereby to pressurize the substance in the pressure chamber.

20. The pressure inducing device for pressurizing a substance as claimed in claim 17, in which the outlet is arranged to open after the substance has been pressurized in the pressure chamber thereby to enable the substance to expel from the pressure chamber through the outlet.

21. The pressure inducing device for pressurizing a substance as claimed in claim 18, in which the pressure inducing device is arranged to retract the piston from the extended condition to the retracted condition to open the inlet so as to allow a fresh supply of substance to be fed into the pressure chamber and then again to advance the piston to close the inlet and into the extended condition into the pressure chamber, while the outlet is in a closed condition, thereby to pressurize the fresh supply of substance in the pressure chamber.

22. The pressure inducing device for pressurizing a substance as claimed in claim 19, in which the pressure inducing device includes a hydraulically powered motor for driving the piston to travel between the retracted position and the extended position in the pressure chamber.

23. The pressure inducing device for pressurizing a substance as claimed in claim 20, in which the pressure inducing device includes a hydraulically powered motor for driving the blocking member to displace between the blocking condition and the removed condition.

24. A method of pressurizing a substance, the method including:
providing a pressure inducing device defining a pressure chamber, an inlet leading into the pressure chamber, an outlet leading from the pressure chamber in which the outlet is in the form of an outlet passage having a predetermined length, and a piston arranged to travel along the chamber to pressurize the chamber, the inlet being positioned to open into the pressure chamber when the piston is in a retracted condition and to be closed by the piston as the piston is advanced into the pressure chamber from the retracted condition;
feeding a substance into the pressure chamber through the inlet;
advancing the piston to close the inlet and into an extended condition into the pressure chamber, while the outlet is in a closed condition, thereby to pressurize the substance in the pressure chamber; and
opening the outlet after the substance has been pressurized in the pressure chamber thereby to enable the substance to exit the pressure chamber.

25. A pressure inducing device for pressurizing a substance, the device including:
a body,
a pressure chamber defined by the body;
an inlet leading into the pressure chamber;
an outlet leading from the pressure chamber in which the outlet is in the form of an outlet passage having a predetermined length; and
a piston arranged to travel along the pressure chamber to pressurize the chamber, the inlet being positioned to open into the pressure chamber when the piston is in a retracted condition and to be closed by the piston as the piston is advanced into the pressure chamber from the retracted condition.
